(19) United States
(12) Patent Application Publication
(10) Pub. No.: US 2023/0306373 A1
(43) Pub. Date: Sep. 28, 2023

(54) SMART ACTIONS IN APPLICATION ECOSYSTEM

(71) Applicant: ADP, Inc., Roseland, NJ (US)

(72) Inventors: Dmitriy BESPALOV, Carteret, NJ (US); Rohan PRASAD, Brooklyn, NY (US); Jiabo LI, New York, NY (US); Marmina ABDELMALEK, Union City, NJ (US); Thomas L. ROGERS, New York, NY (US); Kunal DARAL, Kirkland, WA (US); Alexander CHAN, New York, NY (US); Gregory David HUNKINS, New York, NY (US)

(21) Appl. No.: 17/704,900

(22) Filed: Mar. 25, 2022

(51) Int. Cl. G06Q 10/10; G06F 3/0482; G06F 3/0484; G06F 40/279

(52) U.S. Cl. CPC G06Q 10/1053; G06F 3/0482; G06F 3/0484; G06F 40/279

(57) ABSTRACT

Aspects of the present disclosure relate generally to application ecosystems and, more particularly, to navigational and executional operations in an application ecosystem. In embodiments, a method includes: receiving, by a computing device, a natural language request input by a user to perform a task in an application ecosystem of a plurality of applications; determining, by the computing device, an actionable task from the natural language request to perform in the application ecosystem; generating, by the computing device, a user interface screen to perform the task with input parameters required to perform the task populated in elements of the user interface screen derived from the natural language request; and performing the task with the input parameters required in the application ecosystem of the plurality of applications.

### TECHNICAL FIELD

The present disclosure relates generally to application ecosystems and, more particularly, to navigational and executional operations in an application ecosystem.

### BACKGROUND

Current application platforms promote rapid integration of many applications into an entire ecosystem of applications used by their customers and partners. Previously, the workflow of many tasks was performed within a single monolithic application or suite of applications. The advent of prebuilt integrations and new tools from application providers along with the development of low code application platforms has significantly simplified and accelerated application integration for ecosystems. Many enterprise workflows extend across multiple applications, some of which are owned by the enterprise and others that belong to customers and partners.

For example, onboarding a new employee into a company involves interactions between dozens of applications including applicant tracking, background checking, and a human capital system. In addition to these human resources applications and systems, other applications may be used to add a new employee to the payroll system, connect the new employee with a benefits provider, and perhaps enroll the new employee in learning management, and so on. Some of these applications may be developed or belong to the enterprise and others by partners and customers.

### SUMMARY

In an aspect of the present disclosure, a method includes: receiving, by a computing device, a natural language request input by a user to perform a task in an application ecosystem of a plurality of applications; determining, by the computing device, an actionable task from the natural language request to perform in the application ecosystem; generating, by the computing device, a user interface screen to perform the task with input parameters required to perform the task populated in elements of the user interface screen derived from the natural language request; and performing the task with the input parameters required in the application ecosystem of the plurality of applications.

In another aspect of the present disclosure, there is a computer program product including one or more computer readable storage media having program instructions collectively stored on the one or more computer readable storage media. The program instructions are executable to: receive, by a computing device, a natural language request input by a user to perform a task in an application ecosystem of a plurality of applications; send, by the computing device, the natural language request to perform the task to a cloud-based service providing the application ecosystem; display, by the computing device, a user interface screen to perform the task with input parameters required to perform the task populated in elements of the user interface screen derived from the natural language request; and send, by the computing device, an indication from the user to perform the task to the cloud-based service providing the application ecosystem.

In a further aspect of the present disclosure, there is a computer system including a processor, a computer readable memory, one or more computer readable storage media, and program instructions collectively stored on the one or more computer readable storage media. The program instructions are executable to: receive, by a computing device, a natural language request input by a user to perform a task in an application ecosystem of a plurality of applications; determine, by the computing device, an actionable task from the natural language request to perform in the application ecosystem; generate, by the computing device, a user interface screen to perform the task with input parameters required to perform the task populated in elements of the user interface screen derived from the natural language request; and perform the task with the input parameters required in the application ecosystem of the plurality of applications.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 is an illustrative architecture of a computing system according to embodiments of the present disclosure.

FIG. 2 shows an exemplary cloud computing environment in accordance with aspects of the present disclosure.

FIG. 3 is a block diagram illustrating an exemplary environment in accordance with aspects of the present disclosure.

FIG. 4 depicts an exemplary executional operation in accordance with aspects of the present disclosure.

FIGS. 5A and 5B depict exemplary navigations in accordance with aspects of the present disclosure.

FIG. 6 shows a flowchart of an exemplary method in accordance with aspects of the present disclosure.

FIG. 7 shows a flowchart of an exemplary method in accordance with aspects of the present disclosure.

FIG. 8 shows a flowchart of an exemplary method in accordance with aspects of the present disclosure.

FIG. 9 shows a flowchart of an exemplary method in accordance with aspects of the present disclosure.

### DETAILED DESCRIPTION OF ASPECTS OF THE INVENTION

The present disclosure relates generally to application ecosystems and, more particularly, to smart actions in an application ecosystem and methods of operation. In more specific embodiments, the present disclosure provides navigational and executional operations in an application ecosystem. For example, an application ecosystem for human capital management such as ADP® NextGen HCM can now provide smart actions in an evolutionary user interface system for users to interact with the application ecosystem. Advantageously, aspects of the present disclosure provide a novel mechanism in which users can access navigational and executional actions they want to perform in an application ecosystem that is faster than traditional menu-driven access and without the need of an in-depth familiarity of the application ecosystem or user interfaces of the application ecosystem. For example, a user can be navigated easily to a deeply embedded page of an ecosystem to perform the desired action, and the user can specify in the query any parameters necessary to perform the desired action that are used to prefill input parameters on the page for the desired action.

In more specific embodiments, a user may access navigational and executional operations within an application ecosystem, such as ADP® NextGen HCM, by entering a natural language request in the application ecosystem, for instance, as a search query in a global search bar of the home page of the application ecosystem. Accordingly, the user may simply describe their intention in a query typed in a search bar. The system, in embodiments, applies machine learning classifiers to determine an actionable navigational or executional operation of the application ecosystem in the request. As part of understanding what action the user is requesting, the system, in embodiments, may also apply machine learning classifiers to determine required parameters of an actionable task of the application ecosystem in the request. Thus, the machine learning classifiers can learn how a user expresses their intent and understand the actions desired to be performed in the ecosystem.

The system presents the action to the user in an executable format as a search result in the global search bar which the user may select, in embodiments. For a navigational operation presented as a search result, the system generates a hyperlink (“link”) to a page in the application ecosystem that can be loaded on the user's device if selected. Thus the user can click this link and be taken to the page the user desires to visit. For a selected executional operation presented as a search result, the system may generate a display page, in embodiments, for performing the task with input parameters populated in elements of the display page derived from the request and sends the display page to the user for presentation. For example, the system can show a confirmation box of the intended outcome if the user typed out “take leave from Monday to Thursday” for instance. The confirmation box would confirm the dates understood and possibly allow the user to enter any additional information needed to take the leave (such as notes for manager etc.). Once the user confirms this information, and changes it if needed on this confirmation box, the user can submit their leave by just clicking a confirmation button displayed.

Upon receiving confirmation by the user to perform the task with the input parameters, the system, in embodiments, executes the task in the application ecosystem. Such interface access to the ecosystem is faster than traditional menu-driven access and without the need of an in-depth familiarity of the application ecosystem or user interfaces of the application ecosystem to navigate to a deeply embedded page or perform an action by specifying the details of the action in a natural language request.

Moreover, the system responds to the user's description of the navigational and executional actions they want to perform and helps the user execute the action, instead of the user adapting to the system and learning the system's menu-driven navigational and executional user interface and application ecosystem workflow to perform desired tasks. By adapting to the user, aspects of the present disclosure help a user become acclimated to the ecosystem of applications.

Embodiments of the present disclosure may be implemented in many different application ecosystems, such as an application ecosystem of productivity tools, an application ecosystem for enterprise operations, an application ecosystem for workflow automation, and so forth. For instance, embodiments of the present disclosure may be implemented in an application ecosystem for human capital management that may include such applications as applicant tracking, performance management, payroll, benefits administration, and onboarding among others applications.

The smart actions of the evolutionary user interface system for users to interact with an application ecosystem provide a technical solution to a problem arising from integration of many applications into an entire ecosystem of applications used by an enterprise, their customers and partners. This is done by facilitating access to navigational and executional actions they want to perform in an application ecosystem without the need of an in-depth familiarity of the application ecosystem or menu-driven user interfaces of the application ecosystem. In doing so, the technical solution changes the way computers operate in interacting with users by the technological improvements of deploying machine learning classifiers to understand natural language intentions of a user interacting with the computer system and by translating their requests to performable actions by the computer system and executing those actions, among other features as described herein. Unlike conventional systems where a user learns and adapts to a menu-driven user interface and application ecosystem workflow to perform desired tasks, a computer system implementing the technological improvements of the present disclosure adapts to the user and learns how a user describes the actions they want to perform and helps the user execute the action.

Implementations of the present disclosure may be a system, a method, and/or a computer program product. The computer program product may include a computer readable storage medium (or media) having computer readable program instructions thereon for causing a processor to carry out aspects of the present disclosure.

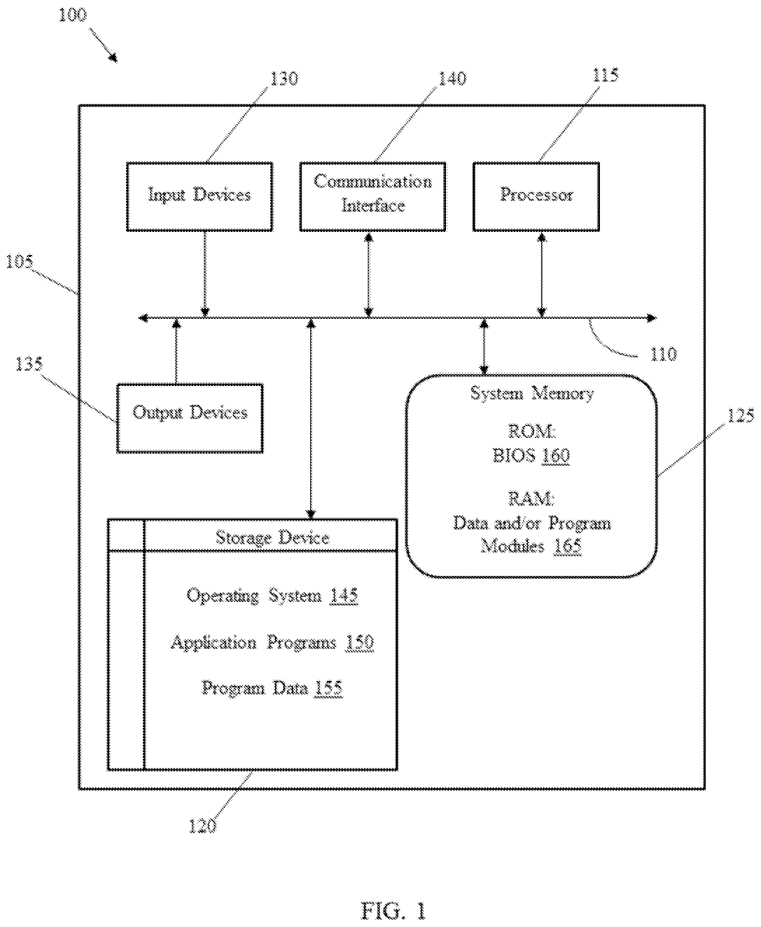

FIG. 1 is an illustrative architecture of a computing system 100 implemented in embodiments of the present disclosure. The computing system 100 is only one example of a suitable computing system and is not intended to suggest any limitation as to the scope of use or functionality of the disclosure. Also, computing system 100 should not be interpreted as having any dependency or requirement relating to any one or combination of components illustrated in computing system 100. Moreover, the system and method described herein may be implemented in the computing system 100 or provided on a computer program product.

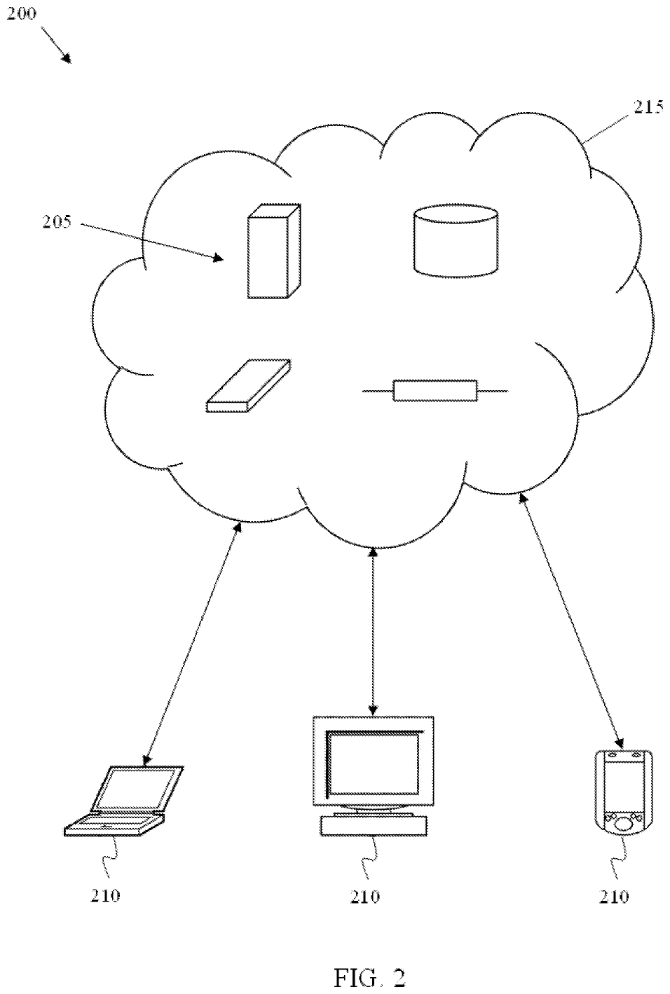

As shown in FIG. 1, computing system 100 includes a computing device 105. The computing device 105 can be resident on a network infrastructure such as within a cloud environment as shown in FIG. 2, or may be a separate independent computing device (e.g., a computing device of a third party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present disclosure, which may be operatively implemented by the computer readable program instructions. For example processor 115 enables the computing device 105 to provide services for users on client devices to request navigational and executional operations within an application ecosystem, deploy machine learning classifiers to understand the natural language intentions of users, translate their requests to performable actions, and execute those actions, as described in more detail herein.

In embodiments, processor 115 may receive input signals from one or more input devices 130 and/or drive output signals through one or more output devices 135. The input devices 130 may be, for example, a keyboard, touch sensitive user interface (UI), etc., as is known to those of skill in the art such that no further description is required for a complete understanding of the present disclosure. The output devices 135 can be, for example, any display device, printer, etc., as is known to those of skill in the art such that no further description is required for a complete understanding of the present disclosure.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present disclosure. In embodiments, storage device 120 may store operating system 145, application programs 150, and program data 155 in accordance with aspects of the present disclosure.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured as a special-purpose computing device providing navigational and executional operations for tasks in an application ecosystem requested in a natural language query from a user. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

FIG. 2 shows an exemplary cloud computing environment 200 in accordance with aspects of the disclosure. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may include one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

In embodiments, software and/or hardware that performs one or more of the aspects, functions and/or processes described herein may be accessed and/or utilized by a client (e.g., an enterprise or an end user) as one or more of an SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

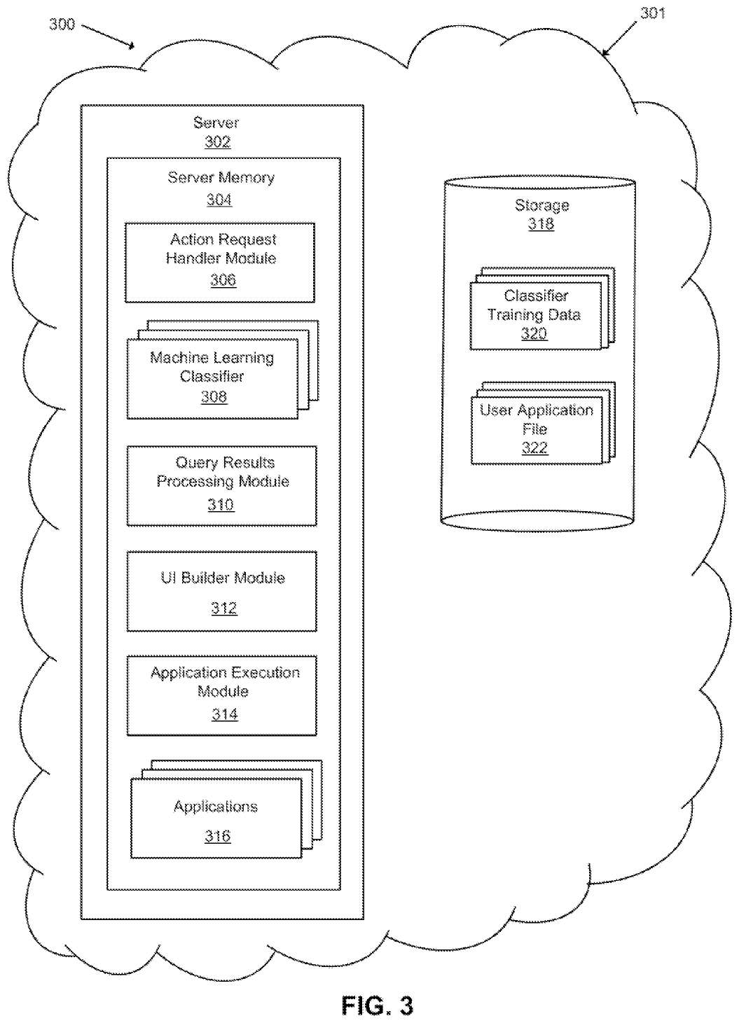

FIG. 3 shows a block diagram of a server in a cloud computing environment in accordance with aspects of the present disclosure. In embodiments, the cloud computing environment 300 includes a server 302, which may be a computing device such as a computing device 105 described with respect to FIG. 1 and is a cloud resource such as cloud resource 205 described with respect to FIG. 2 available to client devices 210 via a network 301, such as the Internet. In general, the server 302 supports services for users on client devices to access navigational and executional operations within an application ecosystem by entering a natural language request in the application ecosystem as a search query.

Server 302 includes, in a server memory 304, such as memory 125 described with respect to FIG. 1, an action request handler module 306 having functionality to handle natural language requests submitted as queries from users on client devices to access navigational and executional operations in an application ecosystem of applications such as applications 316 and machine learning classifiers 308 having functionality to determine an actionable navigational or executional operation of the application ecosystem in a request from a user. The machine learning classifiers 308, in embodiments, also have functionality to determine required parameters of an actionable task of the application ecosystem in a request from a user. In an implementation, there may be a machine learning classifier 308 for each navigational and executional task in the application ecosystem, in embodiments.

The server 302 also includes, in a server memory 304, a query results processing module 310 having functionality to receive actionable navigational and executional operations of the application ecosystem determined by the machine learning classifiers 308 in a request from a user and generate a search results page that displays a link to a page in the application ecosystem for navigational operations that can be loaded on a user's device if selected by a user and displays a link to a page, in embodiments, for executional operations that can be loaded for performing the task with input parameters populated in graphical user interface elements of the display page derived from the request.

The server 302 further includes, in a server memory 304, a user interface builder module 312 having functionality, in embodiments, to generate graphical user interface elements for a display page that performs the task with input parameters populated in elements of the display page. In an implementation, the graphical user interface elements may be provided for the application in the ecosystem that performs the executional operation.

Additionally, the server 302 includes, in a server memory 304, an application execution module 314 having functionality to invoke execution of the navigational and executional operations in the application ecosystem. In an implementation, the application execution module 314 may invoke application programming interfaces of the applications 316 to perform the navigational and executional operations, in embodiments.

And the server 302 includes, in a server memory 304, the applications 316 of the ecosystem that are available to client devices. For example, the applications of an ecosystem for human resources provided as a service to client devices in the cloud computing environment 300 may include applicant tracking, performance management, payroll, benefits administration, and onboarding among others applications.

The action request handler module 306, the machine learning classifiers 308, the query results processing module 310, the user interface builder module 312, the application execution module 314, and the applications 316 may each comprise one or more program modules such as program modules 165 described with respect to FIG. 1. The system may include additional or fewer modules than those shown in FIG. 3. For example, separate modules may be integrated into a single module or a single module may be implemented as multiple modules. Moreover, in practice, the environment may include additional devices and/or networks; fewer devices and/or networks; different devices and/or networks; or differently arranged devices and/or networks than illustrated in FIGS. 1-3.

In accordance with aspects of the disclosure, FIG. 3 also shows a block diagram of a storage system in a cloud computing environment in accordance with aspects of the present disclosure. In embodiments, the cloud computing environment 300 includes a storage 318, which may be a computing device such as a computing device 105 described with respect to FIG. 1 and is a cloud resource such as cloud resource 205 described with respect to FIG. 2 that communicates with the server 302 via a network 301, such as the Internet. In general, the storage 318 may store classifier training data in files 320 that are used to train respective machine learning classifiers 308 on server 302. The training data includes expressions of user intents for actionable operations in the ecosystem of applications. The storage 318 may also store user application files 322 that include information about the user and the user's results of executional operations performed by applications of the ecosystem such as scheduled time off, scheduled meetings, etc.

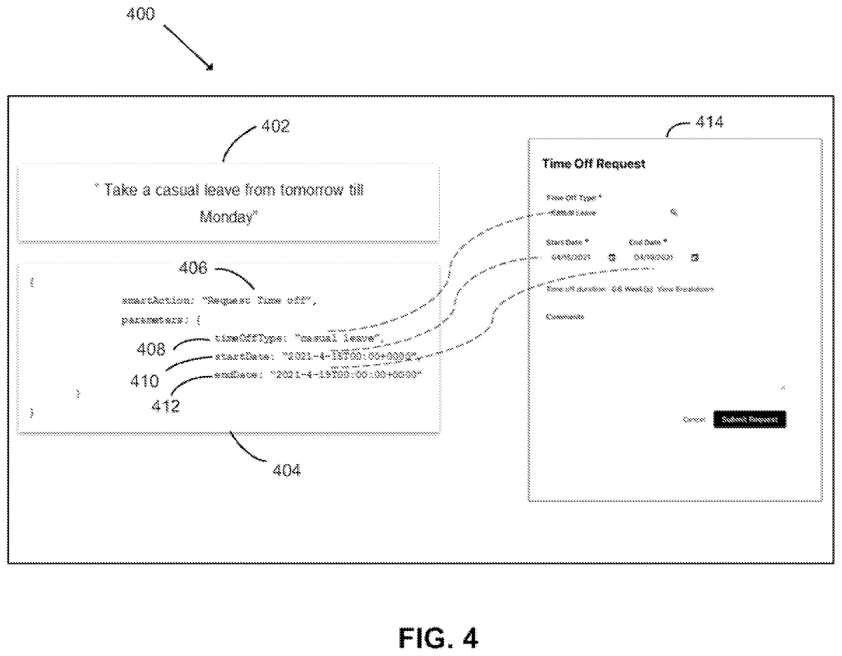

FIG. 4 depicts an exemplary executional operation within a graphical user interface in accordance with aspects of the disclosure. For example, the illustration 400 of FIG. 4 depicts a natural language request, “take a casual leave from tomorrow till Monday,” entered into a search bar 402 of a page of an application ecosystem as a search query. The system of the present disclosure can have declarations of executional operations, such as declaration 404 for each executional operation in each application of the ecosystem. The system employs machine learning classifiers for each of the applications in the ecosystem, in embodiments, to determine an actionable operation for the natural language request for each of the applications in the ecosystem, such as executional operation 406, e.g., “Request Time off,” illustrated in the declaration 404 of the executional operation depicted in FIG. 4.

The executional operation, “Request Time off,” in the declaration 404 may include three parameters declared for the executional operation, “timeOffType” 408 assigned the value of “casual leave”, “startDate” 410 assigned the value of “2021-4-15T00:00+000”, and “endDate” 412 assigned the value of “2021-4-19T00:00+000.” Each of these values assigned to the parameters in the declaration 404 may be derived from the natural language request by a machine learning classifier, in embodiments. For an actionable execution request determined by a machine classifier, the system may generate a display page, such as display page 414, for performing the task with input parameters populated in graphical user interface elements of the display page derived from the request. In embodiments, a user can change the values of the parameters of the executional operations, such as “casual leave” as an example, and can select a graphical user interface control to submit the request to perform the executional operation.

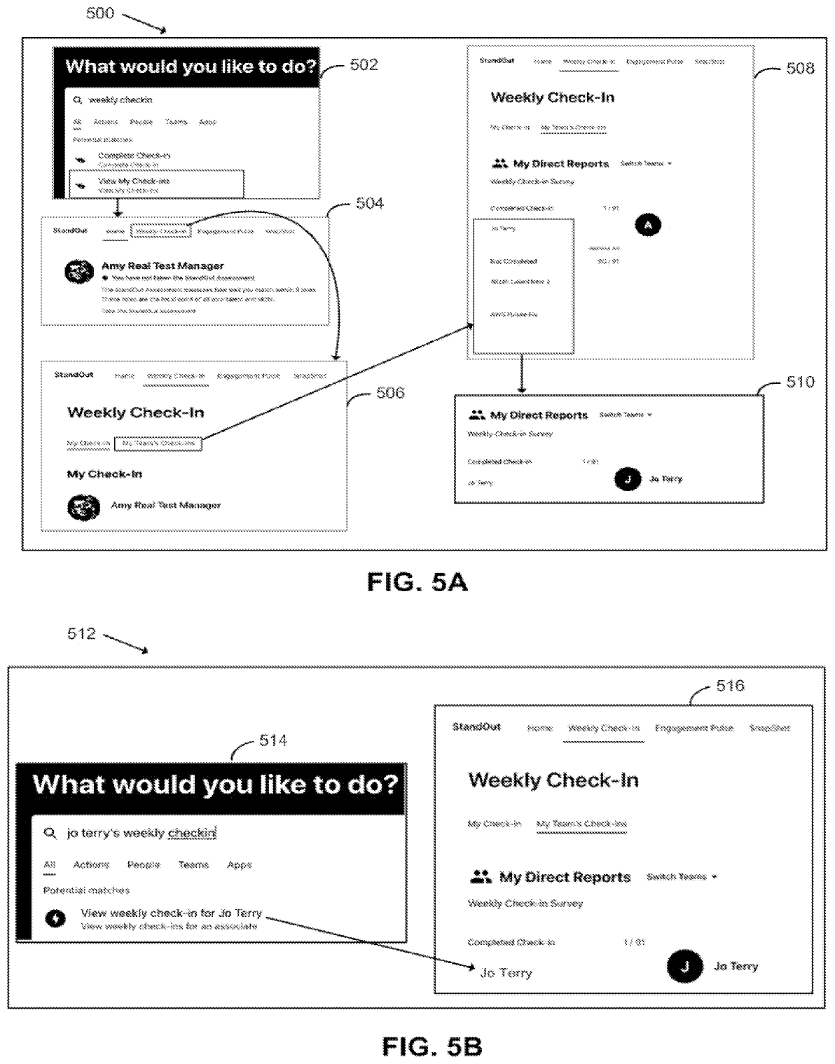

FIGS. 5A and 5B depict exemplary navigation operations in graphical user interfaces in an application ecosystem, in accordance with aspects of the present disclosure. For example, FIG. 5A illustrates a navigation path 500 in an application ecosystem beginning with a page 502 of an application ecosystem with a query, e.g., “weekly checkin” entered in a global search bar and query results from processing the query presented as links entitled “complete check-in” and “view my check-ins.” Selecting the link of “view my check-ins” loads the user's home page 504 for display in the user interface (UI) that includes the link to load the application page “Weekly Check-in” for the user. Selecting the “Weekly Check-in” link in the user's home page 504 loads the application page “Weekly Check-in” 506 for display in the UI for the user that includes a link to “My Check-in” and a link to “My Teams Check-ins.” Selecting the link of “My Teams Check-ins” in the application page “Weekly Check-in” 506 loads the application page “Weekly Check-in” 508 with “My Teams Check-ins” for display in the UI that lists completed and uncompleted check-ins for team members. And selecting the link entitled “Jo Terry” loads the application page, e.g., “My Direct Reports” 510 for display in the UI that shows a completed check-in for team member, Jo Terry. As shown in FIG. 5A, navigating through pages of the application ecosystem from the page 502 with the query “weekly check-ins” to the application page “My Direct Reports” 510 requires user interaction and familiarity with four (4) pages of a navigational hierarchy in the application ecosystem to reach the desired page that shows a completed check-in for a team member, e.g., Jo Terry.

FIG. 5B shows an aspect of the disclosure illustrating that the system, in embodiments, may navigate directly from the page 502 of FIG. 5A to the application page “Weekly Check-in” 516 with “My Direct Reports” given an additional parameter in the natural language query requesting the navigational operation. For example, FIG. 5B illustrates a navigation path 512 in an application ecosystem beginning with a page 514 of an application ecosystem with a query “jo terry's weekly checkin” entered in a global search bar and a query result from processing the query presented as a link entitled “View weekly check-in for Jo Terry.” Upon selecting the link, the system directly navigates to the application page “Weekly Check-ins” 516 showing direct reports for display in the UI including a completed check-in for team member, Jo Terry. Accordingly, the system of the present disclosure may perform navigational operations to directly navigate to a desired application page in an ecosystem requested in a natural language query without requiring the user's interaction and familiarity with the navigational hierarchy in the application ecosystem to reach a desired application page. It should be understood by those of skill in the art that the layout of the interfaces and specific examples described with respect to FIGS. 5A and 5B are for explanation purposes and should not be considered limiting features of the present disclosure.

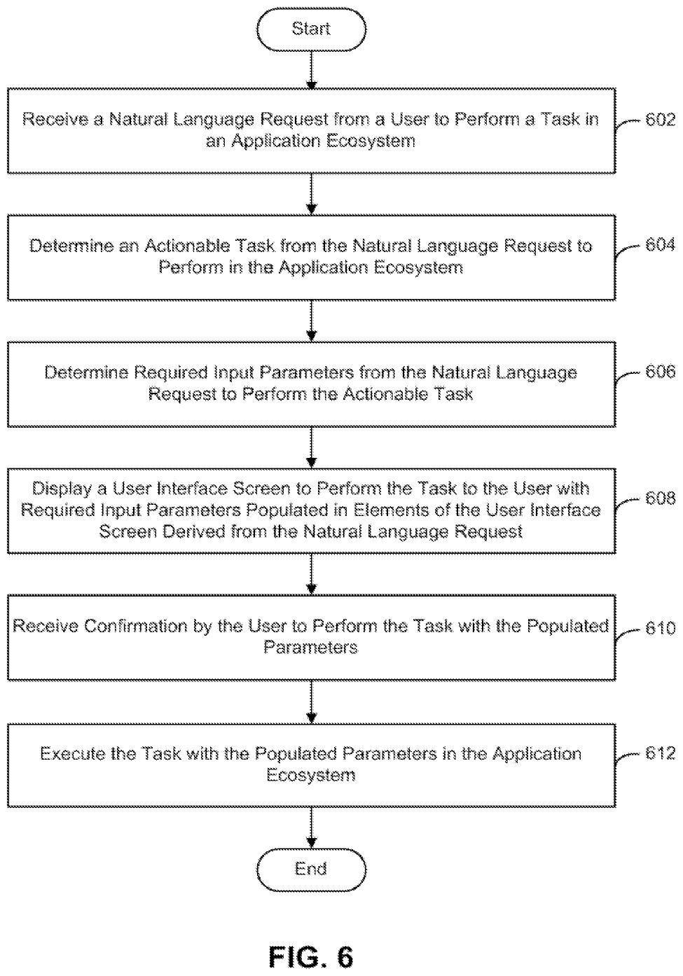

FIGS. 6-9 show flowcharts and/or block diagrams that illustrate the architecture, functionality, and operation of possible implementations of systems, methods, and computer program products according to various embodiments of the present disclosure. Each block may represent a module, segment, or portion of instructions, which comprises one or more executable instructions for implementing the specified logical function(s). The functions noted in the blocks may occur out of the order, two blocks shown in succession may, in fact, be accomplished as one step, executed concurrently, substantially concurrently, in a partially or wholly temporally overlapping manner, or the blocks may sometimes be executed in the reverse order, depending upon the functionality involved. And some blocks shown may be executed and other blocks not executed, depending upon the functionality involved.

Moreover, the exemplary flowcharts and/or block diagrams can be illustrative of a system, a process, and/or a computer program product and related functionality implemented on the computing system of FIG. 1. The computer program product may include computer readable program instructions stored on computer readable storage medium (or media). The computer readable storage medium may include one or more tangible storage medium as described with regard to FIG. 1, e.g., non-transitory media, a tangible device, etc. The processes and/or computer program product implementing the flowcharts and/or block diagrams can be downloaded to respective computing/processing devices, e.g., computing system of FIG. 1 as already described herein, or implemented on a cloud infrastructure as described with regard to FIGS. 2 and 3. Accordingly, the processes associated with the flowcharts and/or block diagrams of the present disclosure can be implemented by special purpose hardware-based systems that perform the specified functions or acts or carry out combinations of special purpose hardware and computer instructions.

FIG. 6 shows a flowchart of an exemplary method in accordance with aspects of the present disclosure. Steps of the method may be carried out in the environment of FIGS. 2 and 3, and are described with reference to elements depicted in FIGS. 2 and 3. In particular, the flowchart of FIG. 6 shows an exemplary method for users on client devices in a cloud computing environment to access navigational and executional operations within an application ecosystem provided by a cloud-based service, in accordance with aspects of the present disclosure.

At step 602, the system receives a natural language request from a user to perform a task in an application ecosystem. For example, a user may access navigational and executional operations within an application ecosystem, in embodiments, by entering a natural language request in the application ecosystem, for instance, as a search query in a global search bar of the home page of the application ecosystem displayed on a client device. In embodiments, an action request handler 306 implemented on a server 302, each described with respect to FIG. 3, may receive the natural language request entered by the user on the client device, such as client device 210 described with respect to FIG. 2.

At step 604, the system determines an actionable task from the natural language request to perform in the application ecosystem. In embodiments, the system applies machine learning classifiers to determine an actionable navigational or executional operation of the application ecosystem in the request. For example, the natural language request entered by a user may be an executional operation requesting time off. In an implementation, there may be a machine learning classifier for each navigational and executional task in the application ecosystem as an example. In embodiments, machine learning classifiers 308 as described with respect to FIG. 3 may determine an actionable navigational or executional operation of the application ecosystem in the natural language request.

At step 606, the system may determine required input parameters from the natural language request to perform the actionable task. As part of understanding what action the user is requesting, the system, in embodiments, applies machine learning classifiers to determine required parameters of an actionable task of the application ecosystem in the request. For example, a natural language request for time off entered by a user may include parameters such as the type of time off, a start date and an end date for the period of time off. The machine learning classifiers 308 as described with respect to FIG. 3 can determine required parameters of an actionable task of the application ecosystem in a request from a user, in embodiments.

At step 608, the system displays a user interface screen to perform the task to the user with required input parameters populated in elements of the user interface screen derived from the natural language request. For an actionable execution request determined by a machine classifier, a UI builder module 312 described with respect to FIG. 3 can generate a display page, in embodiments, such as display page 414 shown in FIG. 4, for performing the task with input parameters populated in graphical user interface elements of the display page derived from the request. In embodiments, a user can change the values of the parameters of the executional operation populated in graphical user interface elements of the display page as desired.

At step 610, the system receives confirmation from the user to perform the task with the populated parameters. In embodiments, a user on a client device can select a graphical user interface control to confirm the request to perform the executional operation, such as the graphical user interface control labeled “Submit Request” on display page 414 shown in FIG. 4, for example, and the client device can send an indication to perform the executional operation to a server in a cloud computing environment such as server 302 described with respect to FIG. 3. And the action request handler module 306 described with respect to FIG. 3 can receive the indication from the user to perform the task with the populated parameters, in embodiments.

At step 612, the system executes the task with the populated parameters in the application ecosystem. For example, the application execution module 314 described with respect to FIG. 3 can execute the task with the populated parameters in the application ecosystem. In an implementation of the present disclosure, the application execution module 314 described with respect to FIG. 3 may invoke application programming interfaces of the applications 316 to perform navigational and executional operations in the application ecosystem.

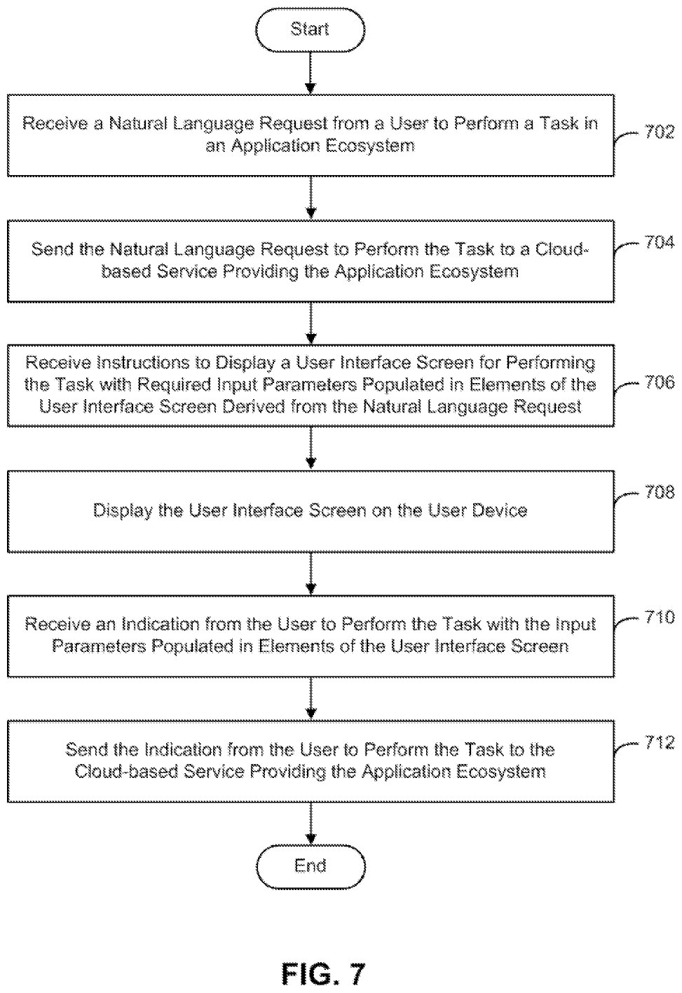

FIG. 7 shows a flowchart of an exemplary method in accordance with aspects of the present disclosure. Steps of the method may be carried out in the environment of FIGS. 2 and 3, and as further described with reference to elements depicted in FIGS. 2-4. In particular, the flowchart of FIG. 7 shows an exemplary method of accessing navigational and executional operations within an application ecosystem by a client device in a cloud computing environment, in accordance with aspects of the present disclosure.

At step 702, a client device receives a natural language request from a user to perform a task in an application ecosystem. For example, a user may enter a natural language request in the application ecosystem as a search query in a global search bar of the home page of the application ecosystem displayed on a client device such as client device 210 described with respect to FIG. 2. In embodiments, a web browser-based portal can be used to provide the UI. Any other configuration can also be used in an implementation to access navigational and executional operations of a cloud-based service providing an application ecosystem, including, for example, a fat client mode, a thin client mode, or a hybrid client mode.

At step 704, the client device sends the natural language request to perform the task to a cloud-based service providing the application ecosystem. For example, the client device, such as client device 210 described with respect to FIG. 2, can send the natural language request to perform the task to a server in a cloud computing environment such as server 302 described with respect to FIG. 3.

At step 706, the client device can receive instructions to display a user interface screen for performing the task with required input parameters populated in elements of the user interface screen derived from the natural language request. For example, the client device, such as client device 210 described with respect to FIG. 2, can receive the instructions from a server in a cloud computing environment, such as server 302 described with respect to FIG. 3, to display a user interface screen for performing the task with required input parameters populated in elements of the user interface screen derived from the natural language request.

At step 708, the client device can display the user interface screen for performing the task with required input parameters populated in elements of the user interface screen derived from the natural language request. For example, a display page, such as display page 414 shown in FIG. 4, may be displayed on a client device, such as client device 210 described with respect to FIG. 2, for performing an executional operation for taking time off with input parameters populated in graphical user interface elements of the display page derived from the request. In embodiments, a user can change the values of the parameters of the executional operation populated in graphical user interface elements of the display page as desired.

At step 710, the client device can receive an indication from the user to perform the task with the input parameters populated in elements of the user interface screen. In embodiments, a user on a client device, such as client device 210 described with respect to FIG. 2, can select a graphical user interface control to confirm the request to perform the executional operation, such as the graphical user interface control labeled “Submit Request” on display page 414 shown in FIG. 4 for example.

At step 712, the client device can send the indication from the user to perform the task to the cloud-based service providing the application ecosystem. Upon a user selecting a graphical user interface control to confirm the request to perform the executional operation, such as the graphical user interface control labeled “Submit Request” on display page 414 shown in FIG. 4 for example, a client device, such as client device 210 described with respect to FIG. 2, can send an indication to perform the executional operation, in embodiments, to a server in a cloud computing environment such as server 302 described with respect to FIG. 3. And the action request handler module 306 described with respect to FIG. 3 can receive the indication from the user to perform the task with the populated parameters.

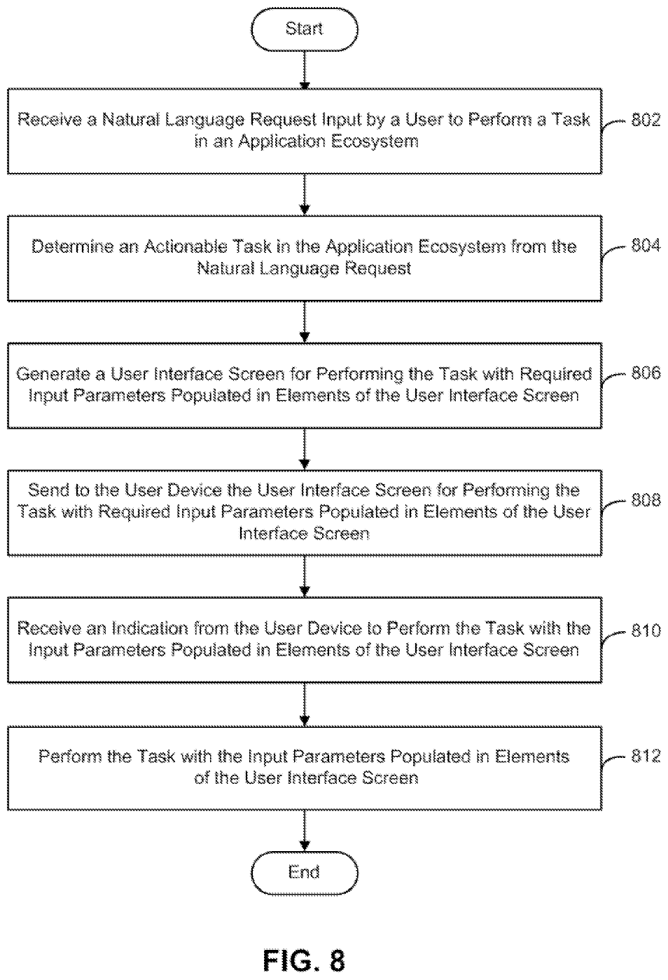

FIG. 8 shows a flowchart of an exemplary method in accordance with aspects of the present disclosure. Steps of the method may be carried out in the environment of FIGS. 2-and 3, and as further described with reference to elements depicted in FIGS. 2-4. In particular, the flowchart of FIG. 8 shows an exemplary method of accessing navigational and executional operations within an application ecosystem by a server in a cloud computing environment, in accordance with aspects of the present disclosure.

At step 802, a server receives a natural language request input by a user to perform a task in an application ecosystem that may include input parameters. For example, a server in a cloud computing environment, such as server 302 described with respect to FIG. 3, can receive a natural language request input by a user on a client device to perform a task in an application ecosystem. In embodiments, an action request handler 306 implemented on a server 302 described with respect to FIG. 3 may receive the natural language request entered by the user on the client device, such as client device 210 described with respect to FIG. 2.

At step 804, the server determines an actionable task in the application ecosystem from the natural language request. In embodiments, the server applies machine learning classifiers to determine an actionable navigational or executional operation of the application ecosystem in the request. For example, the natural language request entered by a user may be an executional operation requesting time off. In an implementation, there may be a machine learning classifier for each navigational and executional task in the application ecosystem, as an example. In embodiments, machine learning classifiers 308 implemented on a server 302 described with respect to FIG. 3 may determine an actionable navigational or executional operation of the application ecosystem in the natural language request.

At step 806, the server generates a user interface screen for performing the task with required input parameters populated in elements of the user interface screen. For an actionable execution request determined by a machine classifier, a UI builder module 312 implemented on a server 302 described with respect to FIG. 3 can generate a display page In embodiments, such as display page 414 shown in FIG. 4, for performing the task with input parameters populated in graphical user interface elements of the display page derived from the request.

At step 808, the server sends to the user device the user interface screen for performing the task with required input parameters populated in elements of the user interface screen. In embodiments, an action request handler 306 implemented on a server 302 described with respect to FIG. 3 can send to a client device, such as client device 210 described with respect to FIG. 2, the user interface screen for performing the task with required input parameters populated in elements of the user interface screen.

At step 810, the server receives an indication from the user device to perform the task with the input parameters populated in elements of the user interface screen. Upon a user selecting a graphical user interface control to confirm the request to perform the executional operation, such as the graphical user interface control labeled “Submit Request” on display page 414 shown in FIG. 4 for example, and the client device, such as client device 210 described with respect to FIG. 2, sending an indication to perform the executional operation, in embodiments, to a server in a cloud computing environment such as server 302 described with respect to FIG. 3, the action request handler module 306 implemented on server 302 described with respect to FIG. 3 can receive the indication from the user to perform the task with the populated parameters, in embodiments.

At step 812, the server performs the task with the input parameters populated in elements of the user interface screen. For example, the application execution module 314 implemented on server 302 described with respect to FIG. 3 can execute the task with the populated parameters in the application ecosystem. In an implementation of the present disclosure, the application execution module 314 may invoke application programming interfaces of the applications 316 to perform navigational and executional operations in the application ecosystem.

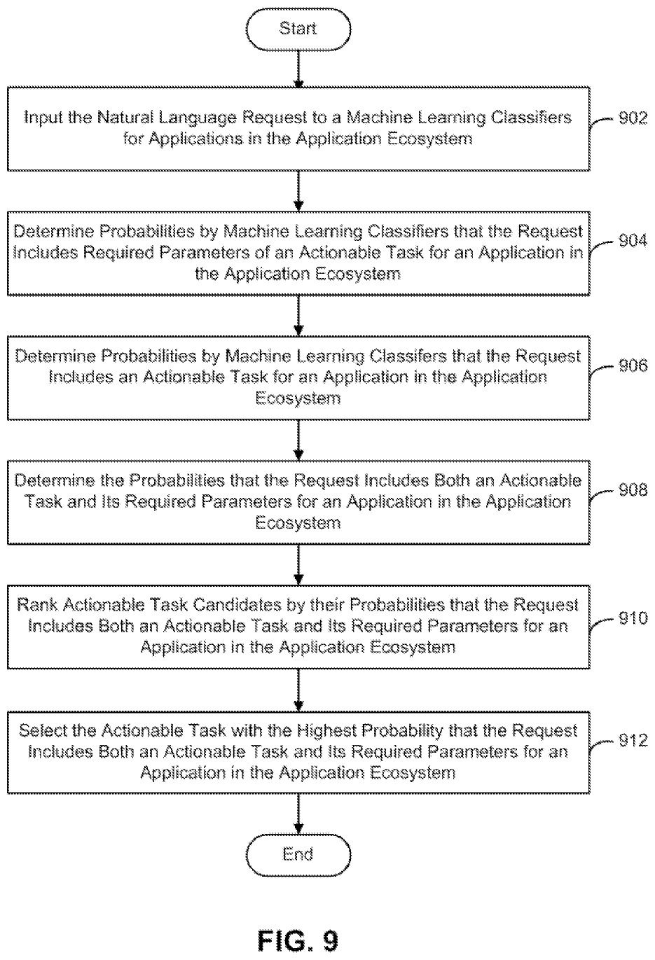

FIG. 9 shows a flowchart of an exemplary method in accordance with aspects of the present disclosure. Steps of the method may be carried out in the environment of FIGS. 2 and 3 and are described with reference to elements depicted in FIGS. 2-3. In particular, the flowchart of FIG. 9 shows an exemplary method of determining an actionable task in the application ecosystem from a natural language request.

At step 902, the server inputs the natural language request to each machine learning classifier for a parameter of an actionable task for each application in the application ecosystem. In embodiments, the action request handler 306 implemented on a server 302 described with respect to FIG. 3 can input the natural language request to each machine learning classifier 318 described with respect to FIG. 3 for each application in the application ecosystem.

At step 904, each machine learning classifier for a parameter of an actionable task determines probabilities that the request includes required parameters of an actionable task for a respective application in the application ecosystem. In embodiments, each machine learning classifier 318 for a parameter of an actionable task implemented on a server 302 described with respect to FIG. 3 can determine probabilities that the request includes required parameters of an actionable task for a respective application in the application ecosystem.

In embodiments, a machine learning classifier may be built and trained as a global supervised text classification model for each navigational and executional operation or action and for each parameter of each navigational and executional operation or action. For example, the executional operation, “Request Time off,” has three parameters for the executional operation, “timeOffType,” “startDate,” and “endDate.” Four machine learning classifiers can be built for this executional operation, one for “Request Time off,” one for “timeOffType,” one for “startDate,” and one for “endDate.” A single text classification model may be built and trained across all users for each model of a navigational and executional operation or action. In embodiments, a text classification model can be built for each parameter of each navigational and executional operation or action and may be trained across all user or may be trained for specific users. For example, the model for the parameter of “timeOffType” for the executional operation, “Request Time off,” may be trained for a specific user. The model for the parameter of “associate” for an executional operation of “View Org Info” to view the name of an associate in an organization may be trained for instance across all users, in embodiments.

Each of these text classification models may be built as an ensemble machine learning text classifier using three types of estimators: a naïve bayes classifier using full word features such as unigram and bigrams, naïve bayes classifier using sub-string and prefix features such as sub-strings of 1-5 characters and prefix strings of up-to 10 characters, and an estimator pipeline that combines text embedding with a knn-classfier using an approximate nearest-neighbor search algorithm. The text embedding can be pre-trained multi-lingual text embeddings, in embodiments.

For a rolling window of 1-3 words in the natural language request, each machine learning classifier for a parameter of an actionable task can predict probabilities for up to 5 candidates that the request includes parameters identified for an actionable task of a respective application in the application ecosystem at step 904 and can predict probabilities for up to 5 candidates that the request includes an identified actionable task at step 906.

At step 906, each machine learning classifier for each navigational and executional operation determines probabilities that the request includes an actionable task for a respective application in the application ecosystem for parameters identified in the request. In embodiments, each machine learning classifier 318 for each navigational and executional operation implemented on a server 302 described with respect to FIG. 3 can determine probabilities that the request includes an actionable task for a respective application in the application ecosystem for parameters identified in the request. For each navigational and executional operation or action such as “Request Time off” or “View Org Info,” probabilities of an actionable task can be predicted from the request given the probabilities predicted at step 904 for parameters identified for an actionable task.

At step 908, each machine learning classifier for each navigational and executional operation determines probabilities that the request includes both an actionable task and its required parameters for a respective application in the application ecosystem. In embodiments, each machine learning classifier 318 for each navigational and executional operation implemented on a server 302 described with respect to FIG. 3 can determine probabilities that the request includes both an actionable task and its required parameters for a respective application in the application ecosystem by multiplying the probability of an identified navigational or executional operation by the probabilities of identified parameters required by the identified navigational or executional operation to obtain a probability that the request includes both an actionable task and its required parameters. In doing so, only non-overlapping windows of words are selected in an embodiment to enforce partitioning of words in the natural language request into parts, where each part is attributed to either the actionable task or one of the of the required parameters for this actionable task. And if there is not a candidate for a required parameter of an actionable task, a zero probability is assigned to the required parameter in determining the probabilities that the request includes both an actionable task and its required parameters.

At step 910, the system ranks actionable task candidates by their probabilities that the request includes both an actionable task and its required parameters for an application in the application ecosystem. In embodiments, a query results processing module 310 implemented on a server 302 described with respect to FIG. 3 can rank actionable tasks candidates by their probabilities that the request includes both an actionable task and its required parameters for an application in the application ecosystem.

At step 912, the system selects the actionable task with the highest probability that the request includes both an actionable task and its required parameters for an application in the application ecosystem. In embodiments, a query results processing module 310 implemented on a server 302 described with respect to FIG. 3 can select the actionable task with the highest probability that the request includes both an actionable task and its required parameters for an application in the application ecosystem.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method, comprising:
receiving, by a computing device, a natural language request input by a user to perform a task in an application ecosystem of a plurality of applications;
determining, by the computing device, an actionable task from the natural language request to perform in the application ecosystem;
generating, by the computing device, a user interface screen to perform the task with input parameters required to perform the task populated in elements of the user interface screen derived from the natural language request; and
performing the task with the input parameters required in the application ecosystem of the plurality of applications.

2. The method of claim 1, further comprising sending to a user device, by the computing device, the user interface screen to perform the task with the input parameters required to perform the task populated in the elements of the user interface screen derived from the natural language request.

3. The method of claim 1, further comprising receiving, by the computing device, an indication from a user device to perform the task with the input parameters required to perform the task populated in the elements of the user interface screen derived from the natural language request.

4. The method of claim 1, further comprising:
inputting, by the computing device, the natural language request to at least one machine learning classifier; and
determining a probability that the natural language request includes the actionable task in the application ecosystem.

5. The method of claim 1, further comprising:
inputting, by the computing device, the natural language request to at least one machine learning classifier; and
determining, by the computing device, a probability that the natural language request includes the input parameters required by the actionable task in the application ecosystem.

6. The method of claim 1, further comprising:
determining, by the computing device, a plurality of probabilities that the natural language request includes the actionable task and the input parameters required by the actionable task, each of the plurality of probabilities indicating the probability that the natural language request includes the actionable task and the input parameters required by the actionable task for an application of the plurality of applications;
ranking, by the computing device, the plurality of probabilities that the natural language request includes the actionable task and the input parameters required by the actionable task; and
selecting, by the computing device, the actionable task and the input parameters required by the actionable task with the highest probability.

7. The method of claim 1 wherein the application ecosystem of the plurality of applications is a human resources application ecosystem.

8. The method of claim 1 wherein the actionable task is a navigational task to display a web page of a uniform resource locator in a web-based application ecosystem.

9. The method of claim 1 wherein the actionable task is a navigational task to display an embedded page of a workflow in the application ecosystem.

10. The method of claim 1 wherein the actionable task is an executional task to perform a function of an application in the application ecosystem.

11. The method of claim 1 wherein the actionable task is a navigational task to display a user interface screen in a menu-driven application ecosystem.

12. A computer program product comprising one or more computer readable storage media having program instructions collectively stored on the one or more computer readable storage media, the program instructions executable to:
receive, by a computing device, a natural language request input by a user to perform a task in an application ecosystem of a plurality of applications;
send, by the computing device, the natural language request to perform the task to a cloud-based service providing the application ecosystem;
display, by the computing device, a user interface screen to perform the task with input parameters required to perform the task populated in elements of the user interface screen derived from the natural language request; and
send, by the computing device, an indication from the user to perform the task to the cloud-based service providing the application ecosystem.

13. The computer program product of claim 12, wherein the executable instructions are further executable to receive, by the computing device, instructions to display the user interface screen to perform the task with the input parameters required to perform the task populated in the elements of the user interface screen derived from the natural language request.

14. The computer program product of claim 13, wherein the executable instructions are further executable to receive the indication from the user to perform the task with the input parameters required to perform the task populated in the elements of the user interface screen derived from the natural language request.

15. A system comprising:
a processor, a computer readable memory, one or more computer readable storage media, and program instructions collectively stored on the one or more computer readable storage media, the program instructions executable to:
receive, by a computing device, a natural language request input by a user to perform a task in an application ecosystem of a plurality of applications;
determine, by the computing device, an actionable task from the natural language request to perform in the application ecosystem;
generate, by the computing device, a user interface screen to perform the task with input parameters required to perform the task populated in elements of the user interface screen derived from the natural language request; and
perform the task with the input parameters required in the application ecosystem of the plurality of applications.

16. The system of claim 15, the program instructions further executable to send to a user device, by the computing device, the user interface screen to perform the task with the input parameters required to perform the task populated in the elements of the user interface screen derived from the natural language request.

17. The system of claim 15, the program instructions further executable to receive, by the computing device, an indication from a user device to perform the task with the input parameters required to perform the task populated in the elements of the user interface screen derived from the natural language request.

18. The system of claim 15, the program instructions further executable to:
input, by the computing device, the natural language request to at least one machine learning classifier; and
determine a probability that the natural language request includes the actionable task in the application ecosystem.

19. The system of claim 15, the program instructions further executable to:
determine, by the computing device, a plurality of probabilities that the natural language request includes the actionable task and the input parameters required by the actionable task, each of the plurality of probabilities indicating the probability that the natural language request includes the actionable task and the input parameters required by the actionable task for an application of the plurality of applications;
rank, by the computing device, the plurality of probabilities that the natural language request includes the actionable task and the input parameters required by the actionable task; and
select, by the computing device, the actionable task and the input parameters required by the actionable task with the highest probability.

20. The system of claim 15, wherein the application ecosystem of the plurality of applications is a human resources application ecosystem.
